(19) United States
(12) Patent Application Publication
(10) Pub. No.: US 2007/0226268 A1
(43) Pub. Date: Sep. 27, 2007

(54) Method of managing metadata and set top box device

(75) Inventor: Hsiu-Hong Chen, Hsinchu (TW)

Correspondence Address: BACON & THOMAS, PLLC, 625 SLATERS LANE, FOURTH FLOOR, ALEXANDRIA, VA, 22314, US

(73) Assignee: Arcadyan Technology Corporation, Hsinchu (TW)

(21) Appl. No.: 11/714,206

(22) Filed: Mar. 6, 2007

(30) Foreign Application Priority Data
Mar. 27, 2006 (TW) 95110573

(51) Int. Cl. G06F 17/30

(52) U.S. Cl. 707/200

(57) ABSTRACT

A method of managing metadata applied in a set top box (STB) device is provided. The set top box device is operable to receive plural types of media data. The method of managing metadata begins with receiving a first media data and a second media data. Next, a first metadata of the first media data and a second metadata of the second media data are separately obtained, and a first metadata table and a second metadata table respectively complying with a specific table are generated. Lastly, the first media data and the second media data are respectively stored in the database according to the context of the first metadata table and the context of the second metadata table.

This application claims the benefit of Taiwan application Serial No. 95110573, filed Mar. 27, 2006, the subject matter of which is incorporated herein by reference.

### BACKGROUND OF THE INVENTION

1. Field of the Invention

The invention relates in general to a method of managing metadata and a set top box device therefor, and more particularly to a method of managing metadata operable to plural types of media data and a set top box device therefor.

2. Description of the Related Art

Along with the advance in communication and compression technology, the TV broadcasting has gradually changed from analog broadcasting to digital broadcasting. The revolution in digital broadcasting has precipitated rapid advance in related industries such as the set top box (STB) industry.

The set top box is operable to receive media data from various sources including TV programs transmitted by a cabled TV, a video on demand (VoD) movie program transmitted by the Internet, an audio video (AV) data transmitted by a personal computer, or media data stored in other storage devices such as a universal serial bus (USB) storage unit. Ordinary consumers use a set top box to receive media data from various sources of media data, and then select and play their favorite media data with the set top box. However, in terms of different types of media data, the columns of the metadata are also different. For example, on the one hand, in terms of the audio data such as a moving picture experts group layer 3 (MP3) file or a windows media audio (WMA) file, the columns of the metadata include author, title, length, and so on. On the other hand, in terms of the image file such as a joint photographic experts group (JPEG) file, the columns of the metadata include file name, resolution, author, and so on. The conventional method of managing metadata stores different types of media data in a corresponding database according to the columns of the metadata. Therefore, the amount of databases in the set top box must be sufficient to store all of the media data that the set top box can deal with.

The conventional set top box has several databases, so the design of the user interface program is subject to considerate restraints and is unable to provide users with more convenient functions. For example, the user is incapable of cross-retrieving different types of media data efficiently. Besides, the set top box must have a storage space large enough to store the databases of different types of media data. Therefore, how to effectively manage plural types of media data received by the set top box has become an imminent challenge to be resolved.

### SUMMARY OF THE INVENTION

It is therefore an object of the invention to provide a method of managing metadata operable to plural types of media data and a set top box device therefor, such that the design of user interface program is more versatile, diversified functions are provided and the required storage space for the databases is reduced.

The invention further achieves the above-identified object by providing a method of managing metadata applied to a set top box (STB) device. The set top box device is operable to receive plural types of media data. The method of managing metadata begins with receiving a first media data and a second media data. Next, a first metadata of the first media data and a second metadata of the second media data are separately obtained, and a first metadata table and a second metadata table respectively complying with a specific table are generated. Lastly, the first media data and the second media data are respectively stored in the database according to the context of the first metadata table and the context of the second metadata table.

The invention further achieves the above-identified object by providing a set top box device operable to receive plural types of media data. The set top box device includes a first importer, a second importer and a database. The first importer is operable to receive the first media data and obtain a first metadata from the first media data. The first importer is further used for generating a first metadata table complying with a specific table. The second importer is operable to receive a second media data and obtain a second metadata from the second media data. The second importer is further used for generating a second metadata table complying with the specific table. The database is used for respectively storing the first media data and the second media data according to the context of the first metadata table and the context of the second metadata table.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a block diagram of a set top box according to a preferred embodiment of the invention;

FIG. 2 is a flowchart of a method of managing metadata according to the preferred embodiment of the invention; and

FIG. 3 illustrates the relationship among media data, metadata tables and a database according to the preferred embodiment of the invention.

### DETAILED DESCRIPTION OF THE INVENTION

The invention provides a method of managing metadata applied to a set top box. The method generates a metadata table complying with a specific table according to the metadata of media data. The set top box stores plural types of media data in the same database according to the metadata tables. The specific table includes all of the columns of the metadata of plural types of media data operable to a set top box.

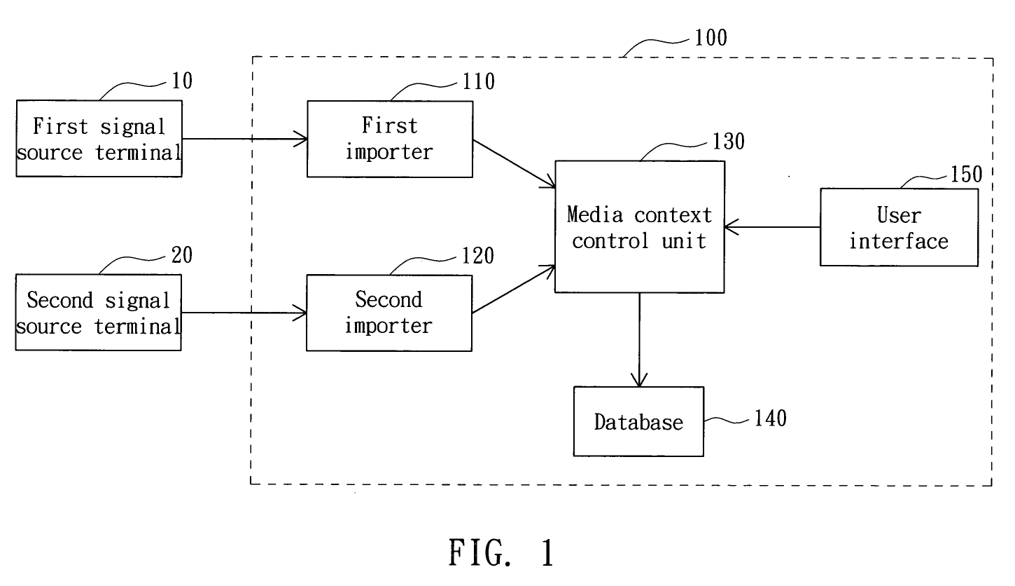

Referring to FIG. 1, a block diagram of a set top box according to a preferred embodiment of the invention is shown. The set top box 100 is operable to receive plural types of media data transmitted by a signal source terminal, for example, TV programs transmitted by a cabled TV, a video on demand (VoD) movie program transmitted by the Internet, an AV data transmitted by a personal computer, or media data stored in other storage devices such as a universal serial bus (USB) storage unit. The invention is exemplified by the set top box capable of receiving two types of media data disclosed above. The set top box 100 includes a first importer 110, a second importer 120, a media context control unit 130 and a database 140. The first importer 110 receives a first media data transmitted by a first signal source terminal 10 and then obtains a first metadata from the first media data. The first importer 110 is further used for generating a first metadata table complying with a specific table. The second importer 120 receives a second media data transmitted by a second signal source terminal 20 and then obtains a second metadata from a second media data. The second importer 120 is further used for generating a second metadata table complying with the specific table. The media context control unit 130 is used for analyzing the context of the first metadata table and the context of the second metadata table. The database 140 is used for respectively storing the first media data and the second media data according to the context of the first metadata table and the context of the second metadata table. The first media data and the second media data are of different types.

The set top box 100 further includes a user interface 150 to access all the media data operable to the set top box 100 by the specific table of uniform format. Since the media data tables corresponding to plural types of media data have the same format, that is, the media data is stored in the same database, the invention is able to design a user interface operable to plural types of media data instead of designing various user interface according to the types of the media data. By doing so, not only the design of the user interface is simplified, but also the functions of the user interface are more diversified and the operation of the user interface is made more convenient.

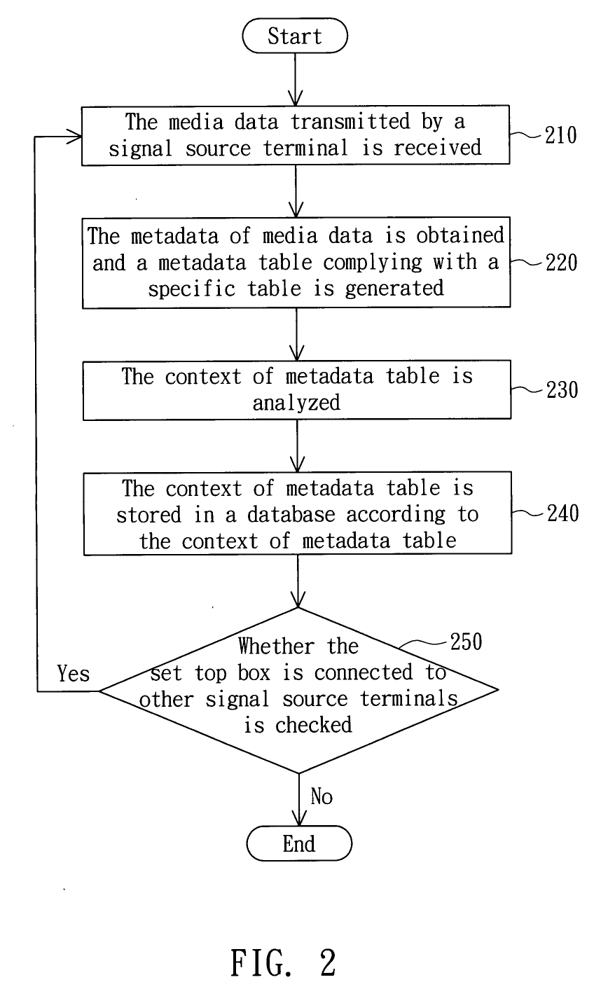

As for how the set top box manages plural types of media data is disclosed below. Referring to FIG. 2, a flowchart of a method of managing metadata according to the preferred embodiment of the invention is shown. After the set top box 100 is turned on, the set top box 100 detects a first signal source terminal 10 connected to the first importer 110. Examples of the first signal source terminal 10 include a host of the Internet. The method of managing metadata begins at step 210, the set top box receives a video on demand (VoD) movie program transmitted by the Internet, that is, the media data transmitted by a signal source terminal. Examples of the VoD programs include a moving picture experts group-4 (MPEG-4) file having metadata to record relevant information of the MPEG-4 file such as file name, author and so on. Next, proceed to step 220, an importer is used to access the metadata of the MPEG-4 file, that is, the metadata of media data, and generate a metadata table complying with a specific table. Then, proceed to step 230, a media context control unit is used to analyze the context of metadata table. Then, proceed to step 240, the media context control unit stores the MPEG-4 file in a database according to the context of metadata table. Lastly, proceed to step 250, whether the set top box is connected to other signal source terminals is checked. If the set top box is connected to other signal source terminals, the method returns to the step 210 of receiving plural types of media data transmitted by other signal source terminals, otherwise, the method of managing metadata is terminated.

The types of media operable to the set top box of the invention is not limited to the first media data and the second media data disclosed in the above embodiment. In practical application, the set top box of the invention is capable of processing more than two types of media data. The set top box has several importers to receive corresponding media data from which corresponding metadata are accessed. The importers use the metadata to generate a metadata table complying with a specific table. Preferably, the specific table according to the embodiment of the invention is of extensible markup language (XML) file format. The XML file format includes all of the columns of metadata of media data operable to the set top box device. Take the above embodiment for example, the columns of the XML file format include columns corresponding to the first metadata, columns corresponding to the second metadata and partial columns of the XML file format corresponding to the first metadata and the second metadata at the same time. In the first metadata table, only the columns corresponding to the first metadata are inputted with data, and in the second metadata table, only the columns corresponding to the second metadata are inputted with data.

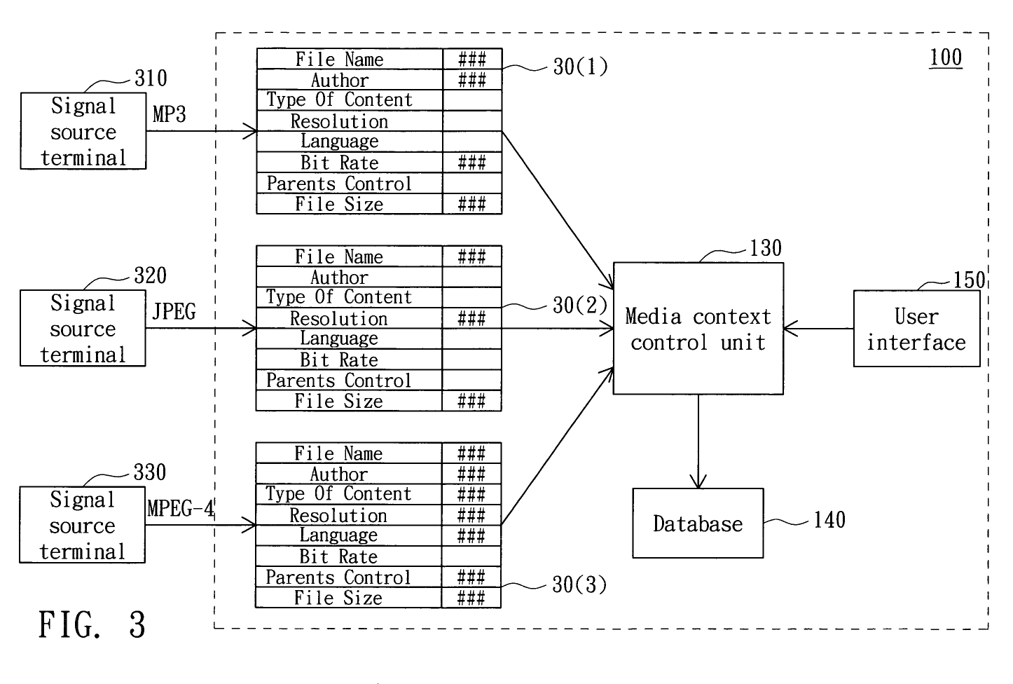

Referring to FIG. 3, the relationship among media data, metadata tables and a database according to the preferred embodiment of the invention is shown. Examples of signal source terminals 310, 320 and 330 include a USB storage unit, a personal computer and a cabled TV respectively outputting an audio data such as MP3 file, an image data such as JPEG file and a video data such as MPEG-4 file to the set top box 100. Importers (not illustrated) are used by the set top box 100 to respectively generate three metadata tables 30(1), 30(2) and 30(3) complying with a specific table. The specific table (not illustrated) is the table before the context of metadata is inputted to the columns of the metadata tables 30(1), 30(2) and 30(2). The metadata tables 30(1), 30(2) and 30(2) include columns such as file name, author, file size and so on. The columns correspond to the columns of the metadata of the MP3 file, JPEG file and MPEG-4 file. However, the metadata tables 30(1), 30(2) and 30(3) still include partial columns. Examples of partial columns include the bit rate column corresponding to the metadata of MP3 file only, the parent control column corresponding to the metadata of MPEG-4 file only, and the resolution column corresponding to the metadata of JPEG file. In the metadata table 30(1), only the metadata columns corresponding to MP3 file are inputted with data. In the metadata table 30(2), only the metadata columns corresponding to JPEG file are inputted with data. In the metadata table 30(3), only the metadata columns corresponding to MPEG-4 file are inputted with data. The metadata tables 30(1), 30(2) and 30(3) are illustrated in FIG. 3. The symbol ### in FIG. 3 denotes that the table is inputted with data. The set top box 100 stores the media data of the MP3 file, the JPEG file and the MPEG-4 file in the database 140 according to the context of the metadata tables 30(1), 30(2) and 30(3). The user can promptly and correctly retrieve the media data stored in the database via the user interface 150.

The set top box of the invention edits the metadata of the received media data to generate a metadata table complying with a specific table, such that the media context control unit is enabled to effectively process plural types of media data and that the design in the function of the user interface is more diversified. For example, the user interface can retrieve the media data of different tables such as the MP3 songs and the MPEG4 movies by the same author. The retrieve function among the media data of different tables can not be achieved by conventional technology. The invention provides the user with more functions. Compared with the conventional set top box which uses several databases to store different types of media data, the set top box of the invention is capable of storing plural types of media data in the same database, not only effectively reducing storage space but also decreasing the cost of the set top box.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method of managing metadata applied in a set top box device, wherein the set top box device is operable to receive a plurality of types of media data, the managing method comprises:
receiving a first media data and a second media data;
seperately obtaining a first metadata of the first media data and a second metadata of the second media data, and respectively generating a first metadata table and a second metadata table both complying with a specific table; and
respectively storing the first media data and the second media data in a database according to the context of the first metadata table and the context of the second metadata table;
wherein the type of the first media data and the type of the second media data are different.

2. The managing method according to claim 1, wherein following the step of generating the first metadata table and the second metadata table, the method further comprises analyzing the context of the first metadata table and the context of the second metadata table.

3. The managing method according to claim 1, wherein the columns of the specific table comprise the columns corresponding to the first metadata, the columns corresponding to the second metadata and partial columns of the specific table corresponding to the first metadata and the second metadata at the same time, in the first metadata table, only the columns corresponding to the first metadata are inputted with data, and in the second metadata table, only the columns corresponding to the second metadata are inputted with data.

4. The managing method according to claim 1, wherein the specific table is of extensible markup language file format.

5. The managing method according to claim 1, wherein the media data comprise audio data, video data or image data.

6. The managing method according to claim 1, wherein the first media data or the second media data is an MPEG file, an MP3 file, a VoD program, a WMA file, a JPEG file, a digital TV program, or a cabled TV program.

7. A set top box device operable to receive a plurality of types of media data, wherein the set top box device comprises:
a first importer operable to receive a first media data and obtain a first metadata from the first media data, wherein the first importer is further used for generating a first metadata table complying with a specific table;
a second importer operable to receive a second media data and obtain a second metadata from the second media data, wherein the second importer is further used for generating a second metadata table complying with the specific table; and
a database used for respectively storing the first media data and the second media data according to the context of the first metadata table and the context of the second metadata table;
wherein the type of the first media data and the type of the second media data are different.

8. The set top box device according to claim 7, comprising a media context control unit used for analyzing the context of the first metadata table and the context of the second metadata table.

9. The set top box device according to claim 7, wherein the columns of the specific table comprise the columns corresponding to the first metadata, the columns corresponding to the second metadata and partial columns of the specific table corresponding to the first metadata and the second metadata at the same time, in the first metadata table, only the columns corresponding to the first metadata are inputted with data, and in the second metadata table, only the columns corresponding to the second metadata are inputted with data.

10. The set top box device according to claim 7, wherein the specific table is of extensible markup language file format.

11. The set top box device according to claim 7, wherein the media data comprise audio data, video data or image data.

12. The set top box device according to claim 7, wherein the first media data or the second media data is an MPEG file, an MP3 file, a VoD programs, a WMA file, a JPEG file, a digital TV program, or a cabled TV program.

13. The set top box device according to claim 8, further comprising a user interface used for retrieving the media data stored in the database.

14. The set top box device according to claim 13, wherein the user interface retrieves the media data stored in the database according to the specific table.
